(19) United States
(12) Patent Application Publication
(10) Pub. No.: US 2010/0153248 A1
(43) Pub. Date: Jun. 17, 2010

(54) Portable Service Agnostic Access

(75) Inventors: Abraham Borno, Piscataway, NJ (US); Abdulkarim Abib, Somerset, NJ (US); Roger Aboujaoude, Ocean Township, NJ (US); Kevin Haggerty, Kendall Park, NJ (US); Davinder Prakash, Somerset, NJ (US)

Correspondence Address: AT&T Legal Department - Moazzam;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/335,454

(22) Filed: Dec. 15, 2008

(51) Int. Cl. G06Q 30/00; G06Q 99/00

(52) U.S. Cl. 705/34; 705/1.1

(57) ABSTRACT

Methods are disclosed which relate to providing and billing for a service through a network regardless of the type of transport used to access the network. A customer who wishes to have a certain service first selects a transport. Transport options can be limited by the customer's location and bandwidth needs, but not by the service the customer desires. Once a transport option is selected it is installed and the customer receives the service through the transport by accessing a network. If a customer already has a transport and access to a network but desires another service, then the desired service can be simply added onto the existing access and billed accordingly. The transport type and service are calculated independently for billing purposes.

### BACKGROUND OF THE INVENTION

1. Field of the Invention

The present invention relates to providing services across transports. More specifically, the present invention relates to offering services across any transport such that service options are not limited by transport.

2. Background of the Invention

Information is constantly being sent and received all over the world by a variety of different devices. As of Mar. 31, 2008, it is estimated that over 1.4 billion people access the internet in some way. The technology used for data transport is a rapidly evolving area, utilizing wired as well as wireless networks. These networks provide for connection to groups of interconnected devices which pass data back and forth. Networks provide users with access to a variety of services and systems, such as the internet. With the available means of connection, users can connect to a network in the privacy of their own home or on a crowded subway.

Devices such as cellular telephones allow access to networks on the move and in places once thought unimaginable. Connections to networks can be made through telephone lines, cable lines, fiber optic lines, cellular lines, etc. Many of these means of data transport can also be used for a variety of services, such as voice, internet, cable television, messaging, etc. A customer may have one means of data transport for multiple services, such as a cable line used for internet, cable television, and telephone access.

With new technologies emerging and faster data transport means becoming available in new areas, users may wish to upgrade from their previous service. For instance, a customer with a cable line may decide that he would rather have a fiber optic line than the cable line in order to receive faster internet and a clearer television picture. Currently, this switch means the customer must cancel his cable subscription, possibly incurring early termination fees, and switch to fiber optic line, incurring start-up costs. These occurrences create a loss of time and expense.

Due to continuing evolution of network technologies and the increased demand for network integration, expansion and security, enterprise telecom companies have always been troubled with migrating their customers from the existing network technologies to the newer networks while at the same time reusing the access. Current access arrangements are linked to specific data transport services, resulting in high complexity across varying domains of business. For instance, current pricing models are very complex. This is due to multiple complex business, service delivery, maintenance, and billing processes. Each type of data transport used to access a network is treated separately, requiring separate contracts for each of the transports. Current systems have a lack of flexibility with respect to access re-use. Thus, even though a customer may be switching from coaxial cable to fiber optic cable for access to the network, these transports are treated as separate, requiring canceling one contract and entering into a new contract.

What is needed is an integrated business plan allowing connection to a network through any of a number of data transports and allowing easy movement between the types of transport. With many services becoming digital, services should be provided across any transport.

### SUMMARY OF THE INVENTION

The present invention includes methods of providing and billing for a service through a network regardless of the type of transport used to access the network. A customer who wishes to have a certain service first selects a transport. Transport options can be limited by the customer's location and bandwidth needs, but not by the service the customer desires. Once a transport option is selected, it is installed and the customer receives the service through the transport by accessing a network. If a customer already has a transport and access to a network, but desires another service, then the desired service can be simply added onto the existing access and billed accordingly.

Furthermore, the present invention dissociates certain services with specific transports by allowing any service to run through any transport. For instance, a customer may want non-broadcast television service, but has a house in the mountains where the customer can only receive a cellular signal. According to embodiments of the invention, the customer is sent a cellular transceiver which connects to a network through the cellular signal. Once the transceiver is connected to the network, a non-broadcast television service is enabled by the service provider. The transceiver is also connected to a television where the customer can view the content of the service.

In one embodiment, the present invention is a method of providing a service regardless of access type comprising selecting one of a plurality of transports, accessing a network through the transport, and delivering a service through the accessed network. The service is available no matter which transport is selected.

In another embodiment, the present invention is a method of billing for a service, regardless of access type, comprising determining a transport used for an access, evaluating a cost of the transport, and adding a cost of a first service. The cost of the first service is not dependent on the access.

In yet another embodiment, the present invention is a software program, stored on a computer readable medium, for providing a service, regardless of access type, comprising entering one of personal and business information, selecting one of a plurality of transports, and selecting one of a plurality of services. Each of the plurality of services is available no matter which transport is selected.

### BRIEF DESCRIPTION OF THE DRAWINGS

FIG. 1 shows an overview of a business method comprising sales, accounting, and installation, according to an exemplary embodiment of the present invention.

FIG. 2 shows an overview of the sales portion of a business method, according to an exemplary embodiment of the present invention.

FIG. 3 shows a flow chart of a service agnostic business method, according to an exemplary embodiment of the present invention.

FIG. 4 shows a flow chart of the service provider side of a service agnostic business method, according to an exemplary embodiment of the present invention.

FIG. 5 shows a selection screen for service, access, and transport, according to an exemplary embodiment of the present invention.

### DETAILED DESCRIPTION OF THE INVENTION

The present invention includes methods of providing and billing for a service through a network regardless of the type of transport used to access the network. A customer who wishes to have a certain service first selects a transport. Transport options can be limited by the customer's location and bandwidth needs, but not by the service the customer desires. Once a transport option is selected it is installed and the customer receives the service through the transport by accessing a network. If a customer already has a transport and access to a network but desires another service, then the desired service can be simply added onto the existing access and billed accordingly.

Furthermore, the present invention dissociates certain services with specific transports by allowing any service to run through any transport. For instance, a customer may want non-broadcast television service, but has a house in the mountains where the customer can only receive a cellular signal. According to embodiments of the invention, the customer is sent a cellular transceiver which connects to a network through the cellular signal. Once the transceiver is connected to the network, a non-broadcast television service is enabled by the service provider. The transceiver is also connected to a television where the customer can view the content of the service.

“Transport,” as used herein and throughout this disclosure, refers to the physical cables and/or transceivers necessary to connect to a network. Examples of transports are cables, telephone lines, fiber optic lines, modems, routers, cellular telephones, wireless routers, satellite dishes, cable boxes, etc. Transports can be wired or wireless.

“Access,” as used herein and throughout this disclosure, refers to a data connection to a network. Access requires a transport. However, mere access alone does not include any services. Connection to a network gives a customer the ability to then receive services as explained below.

“Service,” as used in this disclosure, is a feature sold separately from access. Services include voice calls, internet, Short Message Service (SMS), non-broadcast television, Voice Over Internet Protocol (VoIP), Virtual Private Networking (VPN), Virtual Private LAN Service (VPLS), etc. Services require both a transport and access.

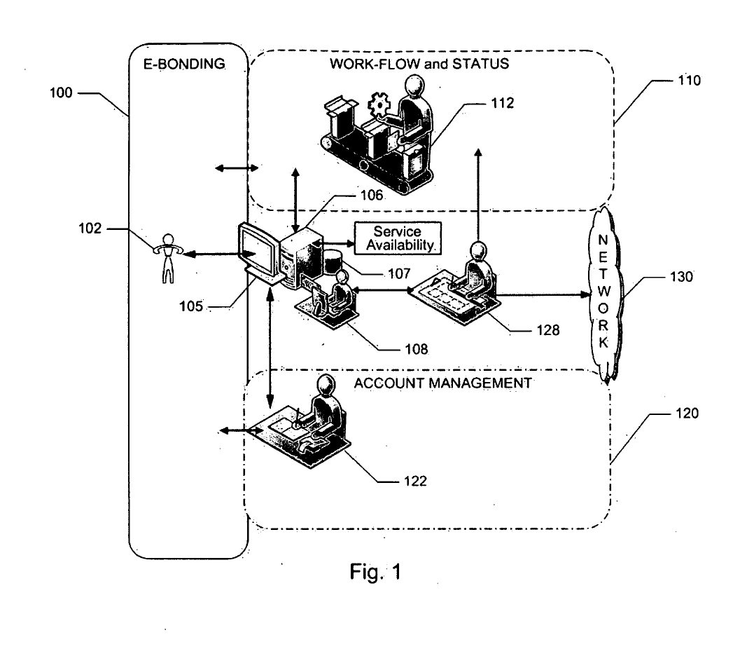

FIG. 1 shows an overview of a business method comprising sales 100, accounting 120, and installation 110, according to an exemplary embodiment of the present invention. In this embodiment, when a customer 102 is interested in acquiring a new service, customer 102 communicates through an electronic interface 105. Electronic interface 105 may be a personal computer, electronic kiosk, portable communication device, etc. In this communication, customer 102 selects the services desired. Electronic interface 105 communicates selected choices with an ordering system. The ordering system is a server 106 with software to assist customer 102 in selection of a service, accept selections, receive customer information, etc. The ordering system has a database 107 which contains information regarding services available in certain areas. A customer service representative 108 may assist in handling sales. Customer service representative 108 may only assist in the event that something is wrong with server 206 of the ordering system or may communicate with customer 102 during the ordering process, such as for answering questions. The ordering system or customer service representative 108 communicates with an engineer 128 who designs the transport based upon customer 102's selections. These designs allow customer 102 the ability to connect to a network 130. The ordering system and engineer 128 are both in communication with delivery implementation 112. Delivery implementation 112 receives orders and installs the physical transport for customer 102. For instance, if customer 102 has selected a fiber optic line but does not have one, delivery implementation 112 sets up the fiber optic line at customer 102's home or business. Delivery implementation 112 may also have direct contact with customer 102. This may be necessary for status updates and instances such as finding out where within customer 102's house a computer or television is set up. Delivery implementation 112 may install the transport directly to these areas. The ordering system also is in communication with account management 122. This allows for billing, receiving, tracking payments, etc. Account management 122 is additionally in communication with customer 102 to assist with established accounts, bill customer 102, receive payments from customer 102, etc.

The previous embodiment features three distinct and separate sections: sales, accounting, and installation. However, these areas need not be so separate. Other embodiments combine sections while some embodiments split them into even more specific sections. Depending on the size of the network, available services, and amount of customers, each business model varies in practice. Other variations of the business model will be readily apparent to one skilled in the art. Many of the features of the previous embodiment can be accomplished by a computer program or by a person.

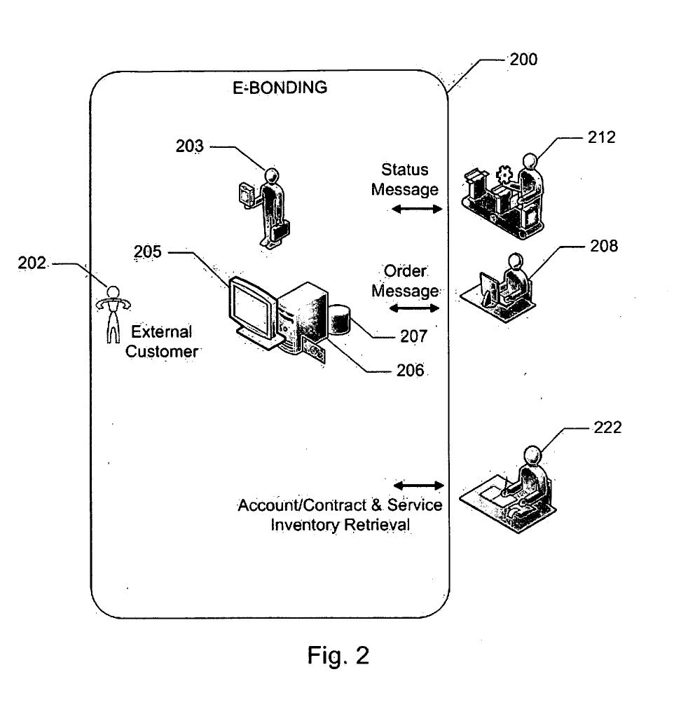

FIG. 2 shows an overview of the sales portion of a business method, according to an exemplary embodiment of the present invention. In this embodiment, a customer 202 has the choice of communicating with a live salesman 203 face to face, communicating over a telephone with live salesman 203, or interacting with an online system through an electronic interface 205. Electronic interface 205 may be a personal computer, electronic kiosk, portable communications device, etc. Electronic interface is in communication with an ordering system which comprises a server 206 and database 207. The server 206 has software to assist customer 202 in the selection of a transport, selection of services, reception of customer information, etc. The database 207 contains information regarding transports available in certain areas, customer information, etc. Live salesman 203 may additionally input sales information into the ordering system after he has communicated with and received an order from customer 202. Customer service representative 208 may be in communication with the ordering system and customer 202 in the event of electronic ordering. Customer service representative 208 may assist in the event that something is wrong with server 206 of the ordering system or may communicate with customer 202 during the ordering process, such as for answering questions. A delivery implementation 212 may additionally communicate with customer 202. This may be necessary for status updates and exact delivery or installation issues. Account management 222 is also in communication with customer 202. This allows for assistance with established accounts, billing of customer 102, receiving payments from customer 102, etc.

Alternatively the live representative and the customer service representative are the same person. The present invention establishes a business model for both sophisticated and unsophisticated customers. The customer service representative can explain options and ensure the unsophisticated customer receives the service they desire. Many sophisticated customers already know exactly the service they want and have a good idea of the transport options available to them if they do not already have transports. For these customers a representative may not be necessary or even desired. A software service selection program is all these customers need, and a customer service representative need only standby in the case of a problem.

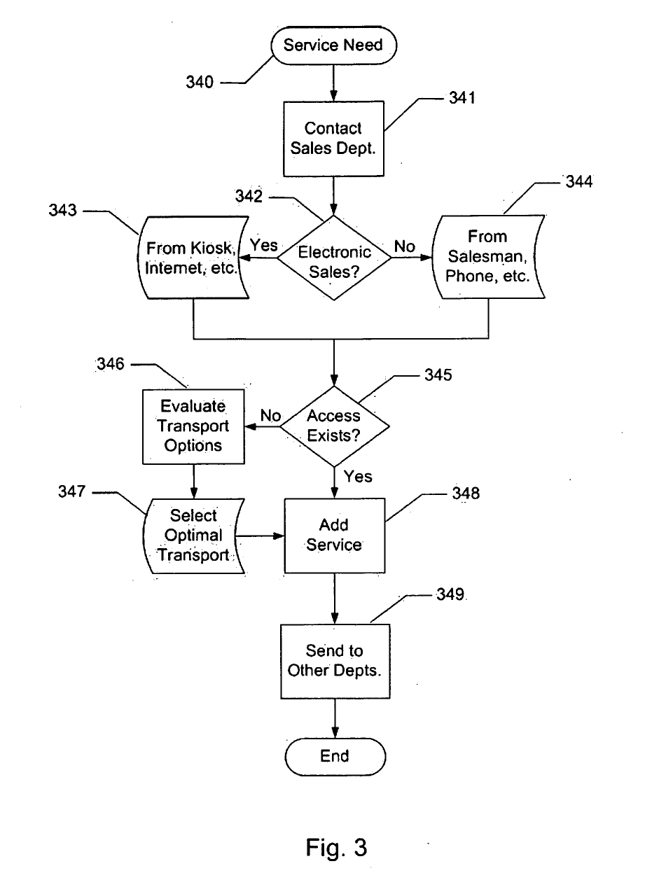

FIG. 3 shows a flow chart of a service agnostic business method, according to an exemplary embodiment of the present invention. In this embodiment, a customer determines that he has the need for a service 340. This can be any number of services, such as phone, television, internet, etc. The customer contacts the sales department 341. The method next determines whether or not the customer contacted the sales department electronically 342. If the contact is electronic, data is received from the customer in ways including over the internet, from a kiosk, etc. 343. If the sales are not electronic, the order is received by a salesman 344, either over the phone, in person, etc. Once the order is received, the method determines whether access to the requested service exists 454. This entails determining if the customer is a current subscriber, what transports the customer has, and whether available transports meet the requirements of the customer. If access does not exist, the transport options are evaluated 346. For instance, the customer may require internet access at higher speeds than available through a cable modem and thus need a fiber optic line. With the evaluation complete, the optimal transport is chosen 347 and the service is added 348. If the access exists already, the service is added 348 to any existing subscriptions. With the service added, a notification is sent to other departments 349 to update all of their records. This tells accounting exactly which services the customer is receiving and bill the customer appropriately. This also tells delivery whether a line is necessary for a wired transport and which transceiver is necessary as well as when to deliver it.

The steps in the foregoing embodiment are achieved in part by a software program and in part by a person. In other embodiments a software program may encompass more steps, as in the case of suiting a sophisticated customer. Most of the sales process may be online on the internet or within a program on a local kiosk. The software program may send details of the sale straight to the accounting and installation departments. For sales that only involve a new service added onto an existing transport, the software program can activate the service itself and need only contact the accounting department in order to bill the customer accordingly.

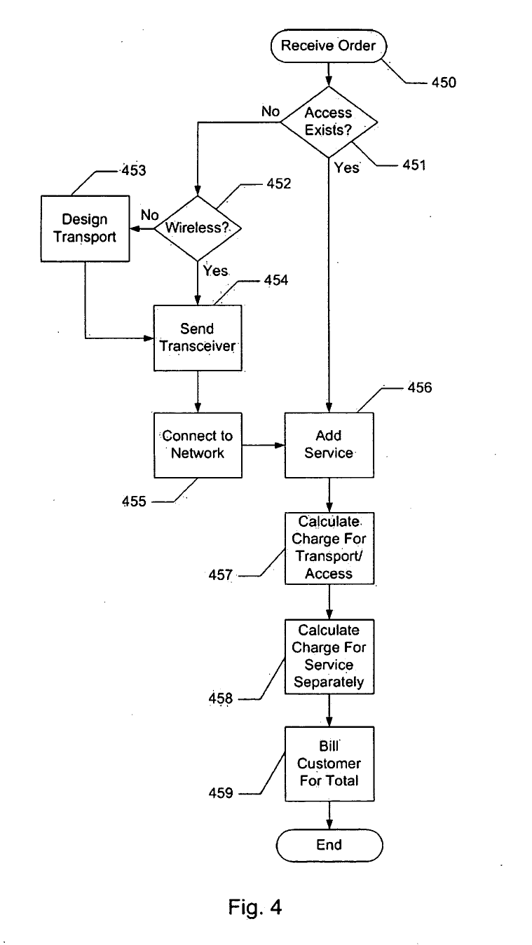

FIG. 4 shows a flow chart of the service provider side of a service agnostic business method, according to an exemplary embodiment of the present invention. In this embodiment, which picks up where FIG. 3 leaves off, an order is received 450. This order may be electronic and directly from a customer or entered by a representative. Once the order is received, it is determined, from the order, whether access already exists 451. This entails determining if the customer is a current subscriber, what transports the customer has, and whether available transports meet the bandwidth requirements of the customer. If access does exist, the service is added 456 to the user's previous services. If access does not exist, it is determined whether or not the required transport is wireless 452. If the desired transport is wireless, the service provider sends a transceiver 454 to the customer. This wireless transceiver is in the form of a cellular telephone, satellite receiver, or other wireless communication device. If the desired service is not wireless, a transport is designed 453 for the desired access. This may be accomplished by installing a phone line, cable line, fiber optic line, etc. With the transport designed, a transceiver is sent 454 to the customer. This transceiver is in the form of a cable box, cable modem, router, or any other wired communication device. Once the transceiver is received, the service provider connects the customer to the network 455 through the transport. With the transport properly connected, the service is added to the customer's subscription. The service order is also received by the accounting department, where the transport and service is billed to the customer. The subscription for the transport is calculated first 457, without any reference to the service. Then the subscription for the service is calculated 458. The cost of the service is not dependent on the transport used. Both subscription costs are billed to the customer 459.

The final stage of the process takes place in accounting. The service provider charges for the transport and access separately from the service. This is so the service provider can present a simple pricing scheme to the customer. Each transport option is presented to the customer as an option. A customer may initially be limited by transport options available in his or her location. The remaining options can be priced by bandwidth capacity. For instance a transport featuring a lower bandwidth capacity has a lower price than a transport featuring a higher bandwidth capacity. Some customers know how much bandwidth they need and limit their options from there. The transport option has no effect on the cost of the service, however. The pricing options presented to the customer are easy to follow and understand. Services may cost more and less depending on the complexity. For instance an internet connection can be lower priced because the network is already connected to the internet. Delivering the internet to a customer merely requires opening a gateway. In the alternative a non-broadcast television service can be higher priced because royalty payments need to be paid to each station. Instead of a separate price for each service and transport combination, the billing in this method is simplified to merely an addition of the price of the transport and the price of the service. The customer can digest all of their options more quickly and can understand the bill more easily.

The software program used in the sales portion above is easily integrated into any computer system. It is connected to the service provider's network as well, so that when a customer orders a service the service order is delivered instantly. The software program may be loaded onto a website where a customer can access it from his home or business. Alternatively it can be loaded onto a kiosk inside a store or mall where a service provider can attract more customers. Customer service representatives can use the same software program to finalize customer orders that a customer uses himself online. A software program need only contain a few key elements such as a location identifier, a list of transports options, and a list of service options. Other features can be added on top such as manager overrides, selection of accessories, other offers, coupon codes, etc. Other useful features of the software program will be readily recognizable by one skilled in the art.

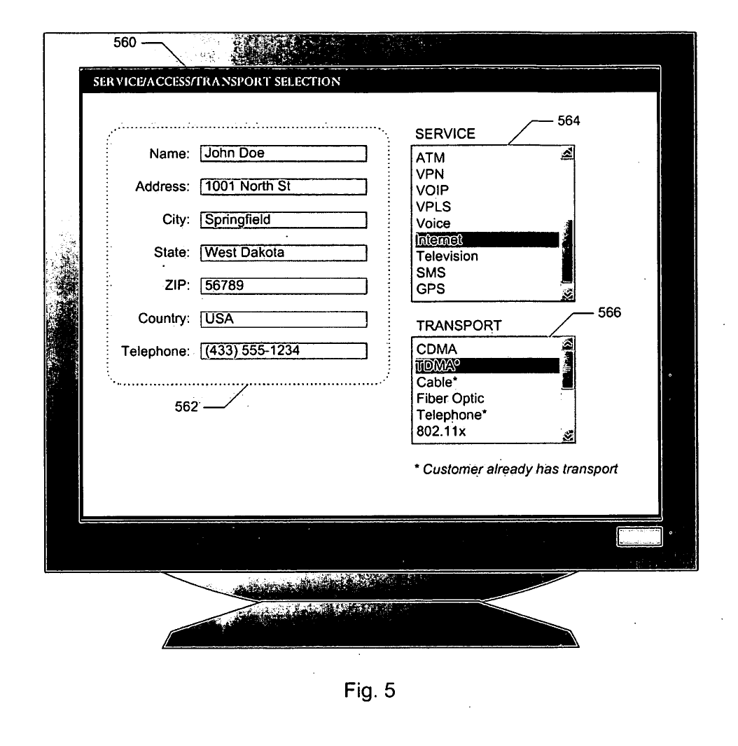

FIG. 5 shows a selection screen for service, access, and transport, according to an exemplary embodiment of the present invention. In this embodiment a customer is prompted to enter his information 562, and select his service 564 and transport 566 type. Information 562 includes the user's name, street address, and phone number. While not shown in the figure, information 562 may also include a username, password, date of birth, credit card information, etc. Service 564 allows the customer to select the type of service he desires. Service 564 options include, but are not limited to, ATM, VPN, VOIP, VPLS, voice, internet, television, SMS, GPS, etc. Customer may also select the type of transport 566 desired. This allows the customer to choose the speed and mobility of access. Transport 566 options include, but are not limited to, CDMA, TDMA, cable line, fiber optic line, telephone line, 802.11x, etc. In this embodiment an asterisk is placed next to the name of any transport the customer currently has. Thus, the customer can select from these and avoid the time and expense of adding a new transport.

Some customers may find themselves adding or discontinuing services frequently. For these customers a user name and a password to login to their profile makes the selection process faster. If the customer needs help while selecting services, a link to a customer service representative may be present. The link may initiate a text relay or “chat” session with a representative. Alternatively, the link may provide a voice relay and even a video connection with a representative. Some transport options may yield a choice in transceivers, particularly when the customer wants a cellular telephone with voice service. There are many cellular telephones to choose from today. Once sale of the transport type is complete, another screen is shown with a selection screen of different model cellular telephones. The customer can click on each one for more information or specific features.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of providing a service regardless of access type, comprising:
selecting one of a plurality of transports;
accessing a network through the transport; and
delivering a service through the accessed network;
wherein the service is available no matter which transport is selected.

2. The method in claim 1, further comprising installing the transport.

3. The method in claim 1, wherein the transport comprises a transceiver which communicates with the network.

4. The method in claim 3, wherein the transceiver is one of a modem, satellite dish, cellular telephone, router, and cable box.

5. The method in claim 1, wherein the transport is one of a wired and wireless connection.

6. The method in claim 5, wherein the wireless connection is one of a 802.11x, cellular RF, CDMA, GSM, and a satellite protocol.

7. The method in claim 1, wherein the transport is one of a cable, telephone, power, and fiber optic line.

8. The method in claim 1, wherein the service is one of voice calls, internet, SMS, nonbroadcast television, VoIP, VPN, VPLS, and GPS.

9. The method in claim 1, further comprising billing for the transport and service.

10. The method in claim 9, wherein the cost of the transport is calculated separately from the cost of the service.

11. A method of billing for a service regardless of access type comprising:
determining a transport used for an access;
evaluating a cost of the transport; and
adding a cost of a first service;
wherein the cost of the first service is not dependent on the access.

12. The method in claim 11, wherein the determining comprises adhering to location restrictions and bandwidth requirements.

13. The method in claim 11, wherein the evaluating comprises determining the bandwidth capacity of a transport.

14. The method in claim 11, further comprising adding a cost of a second service.

15. The method in claim 11, wherein the transport is one of a cable, telephone, power, and fiber optic line.

16. The method in claim 11, wherein the first service is one of voice calls, internet, SMS, non-broadcast television, VoIP, VPN, VPLS, and GPS.

17. The method in claim 14, wherein the second service is one of voice calls, internet, SMS, non-broadcast television, VoIP, VPN, VPLS, and GPS.

18. A software program, stored on a computer readable medium, for providing a service regardless of access type comprising:
entering one of personal and business information;
selecting one of a plurality of transports; and
selecting one of a plurality of services;
wherein each of the plurality of services is available no matter which transport is selected.

19. The software program in claim 18, further comprising a login screen where a user name and a password are entered.

20. The software program in claim 18, further comprising a link to a customer service representative.

21. The software program in claim 20, wherein the link initiates a text relay session with a customer service representative.

22. The software program in claim 20, wherein the link opens a video and audio connection to a customer service representative.

23. The software program in claim 18, wherein the transport is one of a cable, telephone, power, and fiber optic line.

24. The software program in claim 18, wherein the service is one of voice calls, internet, SMS, non-broadcast television, VoIP, VPN, VPLS, and GPS.
